(19) United States
(12) Patent Application Publication
(10) Pub. No.: US 2025/0387696 A1
(43) Pub. Date: Dec. 25, 2025

(54) Video Game Vape Device

(71) Applicant: MUHAMMAD ABBAS KHAN, DALLAS, TX (US)

(72) Inventor: MUHAMMAD ABBAS KHAN, DALLAS, TX (US)

(21) Appl. No.: 18/748,298

(22) Filed: Jun. 20, 2024

(51) Int. Cl. A63F 9/00; A24F 40/44; A24F 40/46; A24F 40/485; A24F 40/49; A24F 40/51; A24F 40/53; A24F 40/57; A24F 40/60; A24F 40/65; A24F 40/95; A63F 13/285; H04N 21/478

(52) U.S. Cl. CPC A63F 9/001; A24F 40/44; A24F 40/46; A24F 40/485; A24F 40/49; A24F 40/57; A24F 40/60; A24F 40/65; A24F 40/95; A63F 13/285; H04N 21/4781; A24F 40/51; A24F 40/53; A63F 2009/0049

(57) ABSTRACT

The present invention discloses an electronic vaping device designed for dual functionality, providing both a vaporizing experience and gaming entertainment. The device features a compact housing that accommodates a mouthpiece, an oil reservoir, an air intake, and a power source. Further the device features a vapor generating arrangement, including an heating element, controlled by an air switch that activates the heating element during use. The airflow intake is configured to intake of air from the external environment, passing through the vapor generating arrangement and exiting through the mouthpiece. Further this device features a PCBA featuring a GPU, and a display configured to provide visual feedback regarding the device's operational status, allowing users to adjust settings, and enabling gameplay on the device. User interaction with the display is facilitated by a plurality of input buttons, proving interface for both vaping and gaming activities.

### FIELD OF THE DISCLOSURE

The present invention relates to a portable vape device, more specifically a video game vape device that allows a user to both play video games and vape on the same device.

### BACKGROUND OF DISCLOSURE

The field of the present invention pertains to portable vaping devices. More specifically, the invention relates to a dual-use portable device that marries the functionality of a video game console and vaping device, herein referred to as a “video game vape device.” This innovative device is designed to offer users the unique capability to engage in well-known video games while enjoying the act of vaping. Additionally, the device is equipped with a child lock feature, ensuring that only individuals who possess the necessary passcode can operate the device, thereby enhancing safety and preventing unauthorized use by minors.

Traditional vaping devices have typically been limited in their interactive capabilities, often featuring small displays that provide minimal user feedback and engagement. These conventional devices primarily focus on the basic functionality of vaping, offering a user experience that some may consider suboptimal. Moreover, a significant portion of the vaping community and video game community have shown a preference for combining the act of vaping with the enjoyment of playing video games, indicating a market demand for a more integrated and engaging user experience.

Existing vaping devices in the market have attempted to incorporate elements of user engagement, such as devices that light up or offer minimal interactive features. However, these attempts have fallen short of providing a truly immersive and satisfying experience for users, often being perceived as mere novelties rather than substantial enhancements to the vaping experience.

The primary objective of the present invention is to significantly enhance the vaping experience by integrating it with digital media consumption, including but not limited to video games, social media, and animations. This integration aims to provide a more enjoyable and memorable vaping experience, allowing users to engage with a wide variety of digital content seamlessly. When not used for vaping, the device serves as a platform for accessing a myriad of well-known video games, receiving mobile notifications, and interacting with other forms of digital media, thus offering added value beyond its primary function.

Another key objective of this invention is to address concerns regarding the use of vaping devices by underage individuals. The inclusion of a child lock feature is designed to prevent accidental or unauthorized use by children, ensuring that the device can only be operated by users who are of legal age and have the requisite knowledge to unlock the device. This safety feature underscores the invention's commitment to responsible use and the protection of vulnerable populations from potential harm.

### SUMMARY OF THE DISCLOSURE

The present disclosure relates to a vape device designed to allow users to interact and play games on the device. The present disclosure comprises of a Video Game Vape Device that includes a housing, a mouthpiece, a battery, an airflow intake, vapor generating arrangement, an oil reservoir, and printed circuit board assembly (“PCBA”).

In one non-limiting aspect of the disclosure, the housing may comprise a front and rear housing.

In one non-limiting aspect of the disclosure, the vapor generating arrangement may comprise a heating element, a tube, and an air switch, wherein the air switch activates the heating element when air flow is detected.

In one non-limiting aspect of the disclosure, the oil reservoir may comprise an oil absorbent cotton, and a cavity enclosed by a top and bottom plug, wherein the oil storage cotton may have a cavity configured to receive the heating element and tube from the vapor-generating arrangement, and wherein the heating element may be configured to heat up the oil in the oil absorbent cotton creating vapor.

In one non-limiting aspect of the disclosure, when the user inhales through the mouthpiece, air is drawn through the airflow intake past the air switch; wherein the air switch is configured to activate the heating element upon detecting airflow, and wherein the heating element heats up the oil in oil absorbent cotton creating vapor; wherein vapor follows along the airflow path through the tube to the mouthpiece, from where it is inhaled by the user.

In one non-limiting aspect of the disclosure, the PCBA may comprise a microcontroller, a display, a storage module, user input array and a GPU; wherein the user input array comprises at least one input module wherein a input key is disposed on top of the input module, and wherein the user input array will allow the user to interact with the display, which may be configured to provide the user visual feedback regarding the device's status, adjust settings, and allow the user to play video games.

In an alternative non-limiting embodiment of the disclosure, the vapor-generating arrangement may comprise a tube, an air switch, and a mesh heating element wherein the oil storage cotton is disposed around the outside of the mesh heating element and tube, when the mesh heating element may create a cavity for air to flow through, wherein the bottom of the tube is connected to the top of said cavity; and wherein vapor may be generated in the heating element mesh cavity and flow up into the tube and out of the device.

In another alternative non-limiting embodiment, the user input array may of at least one directional module, at least one selection module, and at least one power module wherein a directional key is disposed on top of the directional module, a selection key is disposed on top of the selection module and a power key is disposed on top of the power module.

In another alternative non-limiting alternative embodiment, the video game vape device may include a child safety lock, designed to prevent accidental or unauthorized use by children, ensuring that the device can only be operated by users who are of legal age and have the requisite knowledge to unlock the device.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 shows a full view of the Video Game Vape Device

FIG. 2 shows a full view of the Video Game Vape Device with the housing removed.

FIG. 3 shows a deconstructed view of the Video Game Vape Device with the PCBA, and fluid reservoir offset from the device.

FIG. 4 shows a deconstructed view of the Video Game Vape Device with multiple components offset from the device.

FIG. 5 shows exploded view of the Video Game Vape Device.

FIG. 6 shows a bottom view of the Video Game Vape Device.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernible, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

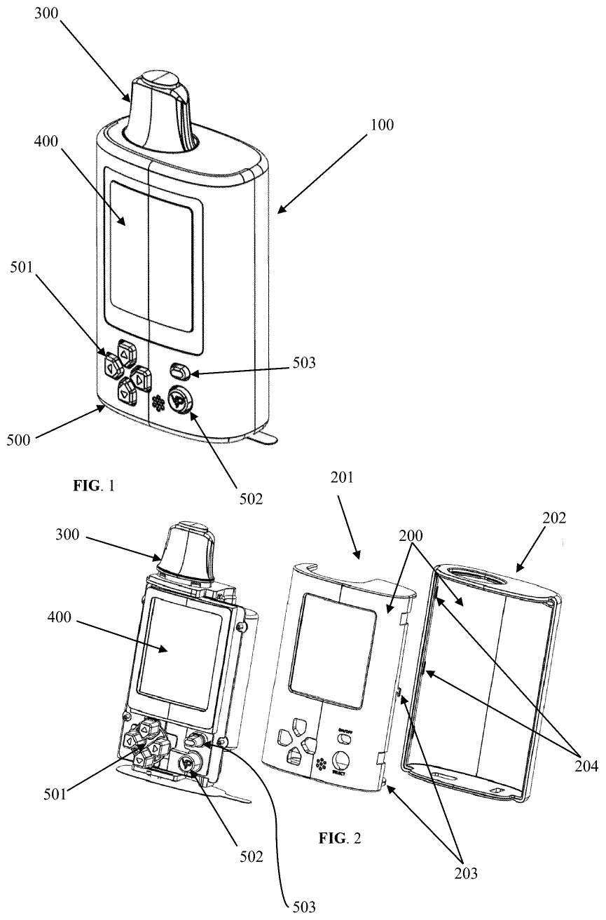

Referring now to the drawings wherein the showings are for the purpose of illustrating non-limiting embodiments of the disclosure only and not for the purpose of limiting same, FIGS. 1-2 illustrate a non-limiting embodiment video game vape device 100 in accordance with the present disclosure. As depicted in FIGS. 1 and 2, video game vape device 100 may comprise a housing 200, a mouthpiece 300, a display 400, and a user input array 500. It should be appreciated that housing 200 may be made of any rigid or semi rigid material including but not limited to, plastic, metal, polymer, composites, elastomers. It should be appreciated that display 400 may comprise any type of display including but not limited to Liquid Crystal Display (LCD), Light Emitting Diode (LED), Organic Light Emitting Diode (OLED), Active Matrix Organic Light Emitting Diode (AMOLED), and MicroLED. Further, it should be appreciated that that display 400 may have any display resolution, such as SD, HD, FHD, UHD, or SHD.

In an alternative non-limiting embodiment, video game vape device may include more than one display 400.

In another alternative non-limiting embodiment, display 400 may comprise a touchscreen.

Further it should be appreciated that in another alternative non-limiting embodiment the device may include a protective film made of elastomers, elastic polymers or any other similar material on the outside of housing 200 to provide impact protection.

Further as depicted in FIGS. 1, 2, 3 and 5 user input array 500 may include at least one multi directional key 501, at least one selection key 502 and at least one Power Key 503. Further as depicted in FIGS. 1 and 2, the at least one multi-directional key 501 may comprise an up key, down key, left key, and a right key. It should be appreciated that the at one multi-directional key 501, at least one selection key 502 and at least one Power Key 503 may comprise any number of tactile input devices, including but not limited to push buttons, toggle switches, rocker switches, rotary buttons, sliders, key switches, DIP switches, tactile switches, emergency stop buttons, joystick buttons, touch-sensitive buttons, and microswitches. In another alternative non-limiting embodiment, the at least one multi-directional key 501, at least one selection key 502 and at least one Power Key 503 may be made of any rigid or semi rigid material, including but not limited to, polymer, rubber, plastic, composites, elastomers or metal.

Further as depicted in FIGS. 1 and 2, housing 200 may also comprise a front housing 201 and rear housing 202.

Further, as depicted in FIG. 2, front housing 201 and back housing 202 may be secured together by a buckle fastener 203 and jack 204 fastener. It should be appreciated that while buckle fastener 203 and jack 204 fastener are used in this embodiment to secure front housing 201 and rear housing 202, they may be secured together by any other means, including but not limited to, friction fit, adhesives, screws and bolts, or clips.

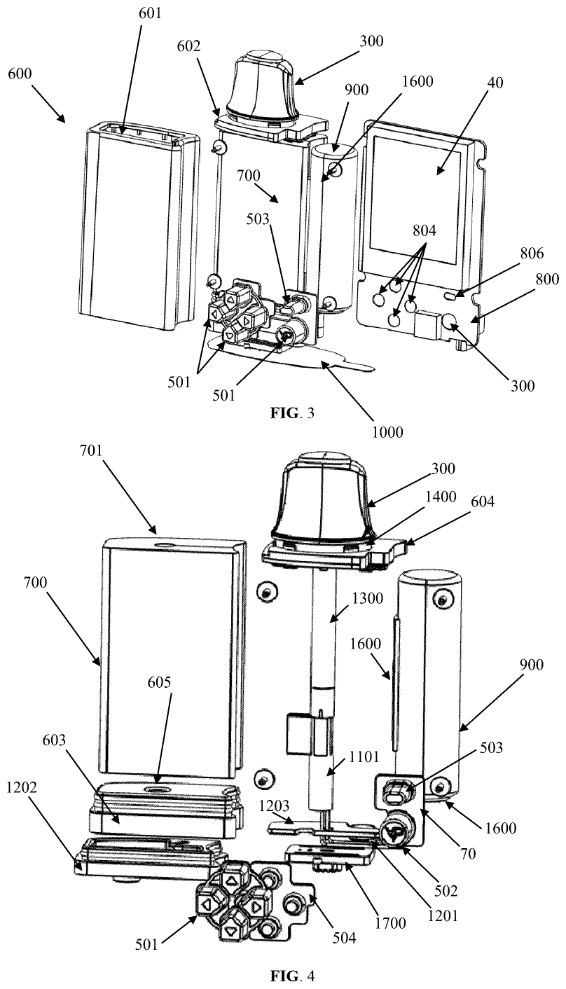

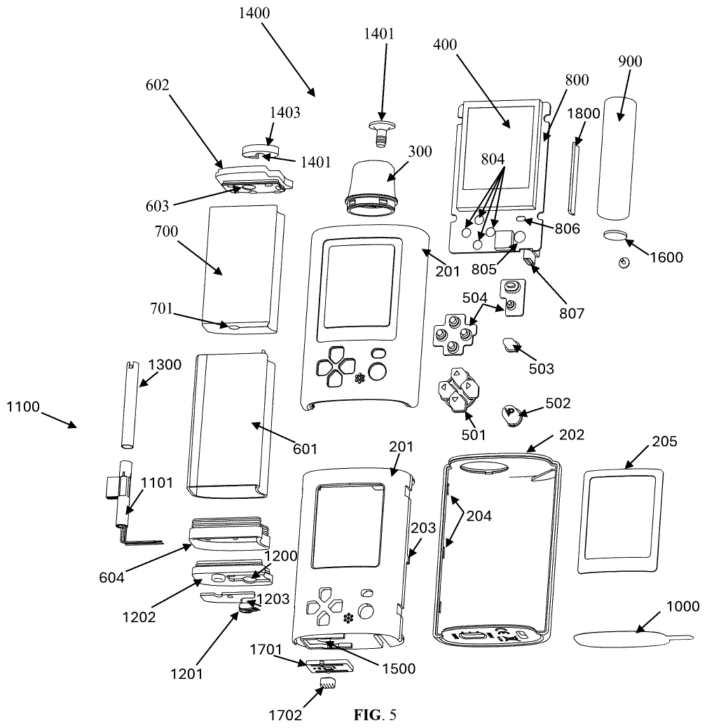

As depicted in FIG. 3, video game vape device 100 may comprise an oil reservoir 600, oil storage cotton 700, a PCBA 800, a battery 900. Further as depicted in FIGS. 3 and 5, PCBA 800 may comprise a Graphics Processing Unit (“GPU”) 801, a microcontroller 802, and storage module 803, a display 400, a directional module 804, a selection module 805, a power module 806, and a charging port 807.

Battery 900 may be rechargeable, and may comprise any type of battery, including but not limited to alkaline batteries, lithium-ion batteries, nickel-metal hydride (NIMH) batteries or lithium-ion polymer batteries.

In one embodiment, directional module 804 will allow a user to navigate the x and y axes of display 400, selection module 803 will allow a user to make selections on display 400, and power module 806 will allow the user to transition video game vape device 100 from an on and off state and reset the device.

PCBA 800 may include any number of input modules.

Charging port 807 may comprise any type of physical electronic connection port, including but not limited to, barrel ports, Micro USB, and USB-C, or means for charging through a electromagnetic field, when the device is set on a charging station.

A video game vape device may comprise more than one PCBA 800.

While oil storage cotton 700 is generally understood to be comprised of any type of absorbent cotton, it can be comprised of any absorbent material. Further, while oil storage cotton 700 will absorb the oil in the device and retain the oil before it is converted to vapor, the oil storage cotton may be used to hold any type of fluid and should not be limited to only be able to retain oil.

In another alternative non-limiting embodiment, oil reservoir 600 may be refillable.

Further, in another alternative non-limiting embodiment fluid reservoir may include a sensor configured to detect how much fluid is left in oil storage cotton 700.

Furthermore, the integration of PCBA 800 with display 400 and the user input arrangement 500 presents a comprehensive interface through which users can interact with the video game vape device. The display serves as the visual gateway to the gaming experience, showcasing graphics and engaging animations, thus user input array 500 allows users to navigate menus, make selections, and actively participate in gameplay. It should be appreciated the device may include multiple keys and buttons for user input and control during game play, including but not limited to a multi-directional key 501 used to navigate the positive and negative x- and y-axes on the display, and selection key 502 used to make selections in games and on menus, and a power key 503 used to turn the device on and off, and to reset the device. It should be appreciated that GPU 801 will enable the device to process and render video games and animations. Further, PCBA 800 via storage module 803 may be capable of housing at least one pre-loaded game on the device.

In another alternative non-limiting embodiment, PCBA 800 provide power and operate a sound-generating device.

In another alternative non-limiting embodiment, PCBA 800 may allow a user to download and install additional games or animations via online platforms.

Further as depicted in FIG. 3, video game vape device 100 may include a port cover 1000. It should be appreciated that port cover 1000 may be made of any flexible water and dust resistant material including but not limited to rubber, plastic, polymer, composite or metal. It should be appreciated that port cover 1000, will prevent water and dust from getting into the device. It should be appreciated that while port cover 1000 is included in the current embodiment, is not required for the device to function.

As depicted in FIGS. 4-5, at least one dampening pad 504 may be disposed between multi-directional key 501 and directional module 804. Further as depicted in FIG. 5, at least one dampening pad 504 may be disposed in between the selection key 502 and selection module 805 and between the power key 503 and the Power Module 806. It should be appreciated that dampening pad 504 will serve to dampen the impact on directional module 804, selection module 805, and power module 806 from the user pressing on the respective keys. It should be appreciated that dampening pad 504 will serve to promote its longevity of the directional module 804, selection module 805, and power module 806. Further, it should be appreciated that dampening pad 504 is not a required for the device to function and should be seen as a non-limiting embodiment. It should also be appreciated that dampening pad 504 may be made of any dampening material including, but not limited to, any elastomer, viscoelastic polymers, foams, rubber composites, or any similar materials. Also, it should be appreciated that dampening pad 504 may be made of any non-conductive material as an added electrical insulation or moisture protection of the internal components.

As depicted in FIG. 4, video game vape device 100 may further comprise a vapor-generating arrangement 1100 comprising of a heating element 1101, an air switch assembly 1200 comprising an air switch 1201, an air switch housing 1202, a non-absorbent member 1203, a tube 1300, and a nozzle assembly 1400. Tube 1300 may be made of any heat resistant rigid materials, and it should be appreciated that while tube 1300 may be rigid in the current embodiment, it can include one or more non-rigid regions. Air switch 1201 is configured to detect airflow, and when air switch 1201 detects airflow, it will energize heating element 1101 until no air flow is detected. Further, air switch housing 1202 may be configured to prevent oil leakage from oil reservoir 600 and to receive air switch 1201. Air switch housing 1202 can be made of any rigid or nonrigid material including but not limited to any elastomer, any polymer, viscoelastic polymers, foams, rubber composites. Non-absorbent member 1203 will serve to prevent liquids from leaking out of air switch housing 1201. Additionally, non-absorbent member 1203 may comprise any non-absorbent or semi-absorbent material including but not limited to hydrophobic cottons, rubber, or any polymers. Heating element 1101 will be used to heat the oil in oil storage cotton 700, resulting in a heated vapor. Generally, heating element 1101 may comprise a resistive heating coil, it may comprise any type of commonly used heating element, including ceramic heating plate, induction heating module, quartz element, infrared radiant heater, or a nickel-chromium alloy element. Vapor-generating arrangement 1100 may comprise more than one heating element 1101.

Further, as depicted in FIGS. 4 and 5, oil reservoir 600 may comprise a cavity 601, a top cavity plug 602 and a bottom cavity plug 604. Further as depicted in FIGS. 4 and 5, cavity 601 may be open on both ends, enclosed on the top-by-top cavity plug 602, and enclosed on the bottom-by-bottom cavity plug 604. Further it should be appreciated that oil storage cotton 700 will fill oil reservoir 600 and soak up fluids for use in the device. Further, while oil storage cotton 700 will generally be used to absorb oil, oil storage cotton 700 can be used to absorb any fluids.

As depicted in FIGS. 4 and 5, top cavity plug 602 may include a top cavity plug hole 603 configured to receive tube 1300, and bottom cavity plug 604 may include a bottom cavity plug hole 605 configured to receive heating element 1101.

As depicted in FIGS. 4 and 5, oil storage cotton 700 may have a cotton cavity 701 configured to receive heating element 1101 and tube 1300.

Heating element 1101 may extend through bottom cavity plug hole 605, and up cotton cavity 701. It should be appreciated that bottom cavity plug 604 will prevent oil from seeping from the bottom of oil reservoir 600. Further, it should be appreciated that bottom cavity plug 604 may be made from any rigid or non-rigid heat resistant material, including but not limited to any elastomer, any polymer, viscoelastic polymers, foams, rubber composites. As depicted in FIG. 4, heating element 1101 may connect to the bottom of tube 1300 and tube 1300 may extend through cotton cavity 701, top cavity plug hole 603, and attach to the bottom of the nozzle assembly 1400.

In another alternative non-limiting embodiment, heating element 1101 may comprise at least one cylindrical mesh coil heating element that extends partially into cotton cavity 701. The outer portion of the cylindrical mesh coil contacts the oil storage cotton 700, while the inner portion forms a cylindrical cavity that connects to the bottom of tube 1300. In this alternative embodiment, the cylindrical mesh will heat and create vapor that will flow from the cyclical cavity up into tube 1300.

It another non-limiting embodiment, heating element 1101 may comprise inner and outer mesh cylindrical coil heating elements that are concentrically aligned, wherein the outer cylindrical mesh is fully encased in oil storage cotton 700 and only the outside of the inner cylindrical mesh contacts the wall of cotton cavity 701, and the inside of inner cylindrical mesh forms a cavity that connects to tube 1300. In this alternative embodiment, the inner and outer cylindrical mesh will heat and create vapor that will flow from the cyclical cavity formed by inner cylindrical mesh up into tube 1300. It should be appreciated that this alternative embodiment would result in quicker vapor generation and extend the life of the cylindrical mesh coil heating elements. In another alterative non-limiting embodiment, the two cylindrical mesh coil heating elements may be in parallel, each creating their own cavity for vapor to form in. In another alternative non-limiting embodiment, there may be more than two cylindrical mesh heating elements.

As further depicted in FIG. 5, front housing 201 may include a gas hole 1500 into which air may flow into the device. Though in FIG. 5, the gas hole 1500 is circular, the hole may be of any shape.

Additionally, as depicted in FIG. 5, nozzle assembly 1400 may comprise a top cavity plug 602, including a top cavity plug hole 603, an oil absorbent membrane 1403, comprising of an oil absorbent membrane hole 1404, an ox plug 1405, and a mouthpiece 300. Ox plug 1405 may restrict air flow through nozzle assembly 1400 to protect the user and provide more dense and better tasting puff. Top cavity plug 602 may be made of any rigid or semi-rigid material, including but not limited to, any elastomer, any polymer, viscoelastic polymers, foams, or rubber composites.

Further, as depicted in in FIG. 4, the top of tube 1300 may extend through the top cavity plug hole 603 of top cavity plug 602 and oil absorbing membrane 1403, through their respective tube holes 1402 and extend though top cavity plug 602 and oil absorbent membrane hole 1404. The user will inhale through mouthpiece 300, air will flow into gas hole 1500 past air switch 1201 into tube 1300, then through nozzle assembly 1400 out mouthpiece 300 into the user's mouth. During operation, airflow will activate air switch 1201 and active heating element 1101; heating element 1101 will then heat up the oil in oil storage cotton 700, resulting in vapor generation. The vapor will follow the airflow through tube 1300 and nozzle assembly 1400 out mouthpiece 300 into the user's mouth. It should be appreciated that top cavity plug 602 will prevent fluid from leaking out of the top of oil reservoir 600. Oil absorbent membrane 1403 may serve to absorb any access oils that are not inhaled by the user when the device is in use to prevent oil from pooling and leaking out of nozzles assembly 1400.

In a non-limiting embodiment air switch 1201 me be configured to interpret the direction of air flow and only activate heating element 1101 if the air flows from gas hole 1500 to mouthpiece 300, and not activate heating element 1101 if air flows from mouthpiece 300 to gas hole 1500. Further in another alternative non-limiting embodiment, when air switch 1201 detects airflow from gas hole 1500 to mouthpiece 300, it will indicate microcontroller 803 and GPU 802 to generate a vape animation on display 400 and a warning message if air switch 1201 detects airflow from mouthpiece 300 to gas hole 1500. Further, this visual feedback may take various forms, including but not limited to color changes, animations, or specific icons, to inform the user that the device is in operation. In another alternative non-limiting embodiment wherein the PCBA includes a sound generating device, microcontroller 803, PGU 802 and the sound generating device may be configured to generate sound associated with the warning message and the vape animation resulting from air switch 1201.

Further as depicted in FIGS. 4 and 5, battery 900 may be attached to the oil reservoir 600 by a foam pad 1600. Further, as depicted in FIGS. 4 and 5, foam pad 1600 may be attached to the bottom of the battery. It should be appreciated that foam pad 1600 may have adhesive compound on each side of it configured secure battery 900 to any surface. Foam pad 1600 may be made of any shock absorbent material including but not limited to foam, rubber, or any similar material. Further it should be appreciated that foam pad 1600 may have adhesive on one or more sides of it to assist in the installation of battery 900. In another alternative non-limiting embodiment, foam pad 1600 may be attached to the top of battery 900 or between housing 200 and battery 900. It should be appreciated that the foam pad 1600 will serve as shock absorber, insulation, and protection, and protect the stability of battery 900. This is an optional embodiment and that battery 900 may be attached to oil reservoir 600 by any means. It should also be appreciated that while the current embodiment includes EVA double sided foam, it is not required, and any means or material can be used to secure battery 900 to oil reservoir 600.

Further as depicted in FIG. 5, front housing 201 may include a decorative patch 205 as an optional feature to enhance the appearance of video game vape device 100.

Further, as depicted in FIGS. 4-6, video game vape device 100 may also include an airflow adjustment assembly 1700.

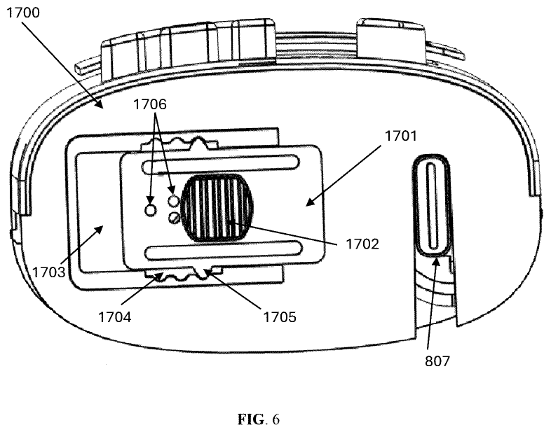

As depicted in FIG. 6, airflow adjustment assembly 1700 may include an airflow adjustment plate 1701, an adjustment knob 1702, and a rectangular slot 1703, adjustment groves 1704, adjustment arms 1705, and adjustment holes 1706. As depicted in FIG. 6, adjustment plate 1701 may include adjustment arms 1705, that match the shape of adjustment groves 1704. Further, adjustment plate 1701 may sit in rectangular slot 1703 and may be adjusted using adjustment nob 1702 by sliding the adjustment plate through the adjustment groves 1704. It should be appreciated that the closer adjustment holes 1706 get to gas hole 1500, the more air that will be able to flow though gas hole 1500 into vapor generation arrangement 1100 and in turn the more vapor that will be generated. It should be appreciated that video game vape device 100 can function without airflow adjustment assembly 1700, and that it should not interpreted as requirement but a non-limiting feature.

In another alternative non-limiting embodiment, video game vape device 100 may incorporate feedback mechanisms, such as vibration or haptic feedback modules. These modules may be configured to provide tactile responses to various interactions, including but not limited to key presses, activation of the air switch 1201, and gameplay on the device. Additionally, these feedback mechanisms may serve to alert the user to a low battery condition, enhancing user experience and device functionality.

In another alternative non-limiting embodiment, the video game vape device 100 may feature a child safety locking system. This system may be designed to prevent unauthorized use, especially by children, ensuring the device can only be activated by users who have successfully entered a predetermined code or sequence. The locking mechanism can be implemented through a combination of physical and digital controls, such as requiring a simultaneous press of multiple buttons or interacting with a specific pattern on the touchscreen display. Additionally, the system could be enhanced with biometric authentication methods, such as fingerprint recognition, to provide an extra layer of security.

In another alternative non-limiting embodiment, the device may feature a library of pre-installed video games, curated to offer users a diverse range of entertainment options directly out of the box. These games span various genres, catering to different preferences and ensuring that users have access to quality gaming content without the immediate need for downloads.

In another alternative non-limiting embodiment, the device may feature capabilities for receiving and installing additional games. It should be appreciated that the games may be installed via wired or wireless connection.

In another alternative non-limiting embodiment, the device may feature an expandable memory module, designed to accommodate the storage needs of both the vaping system and the gaming module. This additional memory capacity would accommodate a wide array of video games, digital content, and user preferences, ensuring that the device can host an extensive library of entertainment options without compromising performance. The expandable memory may also support future updates and expansions, making the device a long-term companion for users.

In another alternative non-limiting embodiment, the device may feature a wireless communication module, enabling it to connect to the internet and communicate with online web applications. This connectivity opens up a realm of possibilities, from downloading new games and updates to accessing online gaming communities and cloud-based services. Further, the user may be able to view real time information about the device including but not limited to battery status, fluid status, and vapor quality.

In another alternative non-limiting embodiment, the device may feature at least one sensor specifically configured to measure the amount of vapor generated during use. This sensor's data can be used to optimize vapor production based on the user's preferences or to maintain consistent vapor output across different environmental conditions.

In another alternative non-limiting embodiment, the device may feature an air quality sensor located within the airflow intake and atomization chamber. This sensor may detect the presence of harmful substances in the air, such as volatile organic compounds or excessive particulate matter that could affect the user's health. Upon detection of any such substances, the device may be configured to alert the user through the display, providing critical information about air and vapor quality issues.

In another alternative non-limiting embodiment, the device may feature a proximity sensor configured to detect the presence of the user's mouth near the mouthpiece. This sensor may activate heating element 1101 in response to detected presence.

In another alternative non-limiting embodiment, the device may include a temperature sensor to monitor the temperature of heating element 1101 and in tube 1300. This sensor may enable PCBA 800 to adjust the power supplied to the heating element 1101, preventing overheating and ensuring optimal vapor production. The regulation of temperature not only enhances the safety of the device by reducing the risk of burns or other heat-related accidents but also ensures that the vapor quality is consistently high, providing a better vaping experience.

In another alternative non-limiting embodiment, the device may contain more than one oil reservoir, enabling users to switch between different vaping oils. This feature would allow for immediate flavor or strength changes without the need to empty and refill a single reservoir, providing flexibility and convenience to the user. The ability to carry multiple oils within a single device also makes it an ideal choice for users who enjoy variety in their vaping experience or who wish to transition between different types of oils throughout the day.

In another alternative non-limiting embodiment, the device may contain a solar panel for charging battery 900.

In another alternative non-limiting embodiment, the device may allow for wireless charging through a pad or mounting structure on which the device is set and charged through interaction with an electromagnetic field.

A legend of components discussed herein follows:
Video Game Vape Device 100
Housing 200
Front Housing 201
Rear Housing 202
Buckle Fastener 203
Jack Fastener 204
Decorative Patch 205
Mouthpiece 300
Display 400
User Input Array 500
Multi directional key 501
Selection Key 502
Power Key 503
Dampening Pad 504
Oil Reservoir 600
Cavity 601
Top Cavity Plug 602
Top Cavity Plug Hole 603
Bottom Cavity Plug 604
Bottom Cavity Plug Hole 605
Oil Storage Cotton 700
Cotton Cavity 701
Printed Circuit Board Assembly (“PCBA”) 800
Graphics Processing Unit (GPU) 801
Microcontroller 802
Storage Module 803
Directional Module 804
Selection Module 805
Power Module 806
Charging Port 807
Battery 900
Port Cover 1000
Vapor Generating Arrangement 1100
Heating Element 1101
Air Switch Assembly 1200
Air Switch 1201
Air Switch Housing 1202
Non-Absorbent Member 1203
Tube 1300
Nozzle Assembly 1400
Oil Absorbent Membrane 1403
Oil Absorbent Membrane Hole 1404
Ox Plug 1405
Gas Hole 1500
Foam Pad 1600
Airflow Adjustment Assembly 1700
Airflow Adjustment Plate 1701
Adjustment Knob 1702
Rectangular Slot 1703
Adjustment Grooves 1704
Adjustment Arms 1705
Adjustment Holes 1706

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. An electronic vape device comprising:
a housing, a mouthpiece, an oil reservoir, a battery, a vapor generating arrangement, an airflow intake;
a PCBA comprising a microcontroller, a storage module, user input array and a GPU, wherein the user input array comprises at least one input module with an input key;
a display configured to provide the user visual feedback regarding the device's status, adjust setting and, allow the user to play video games;

2. The device as described in claim 1, wherein the vapor generating arrangement comprises of a heating element, a tube, and an air switch wherein the air switch configured to activate the heating element when it detects airflow.

3. The device as described in claim 2, wherein the tube is comprised of a rigid material.

4. The device as described in claim 1, wherein the heating element comprises of at least one cylindrical mesh.

5. The device as described in claim 1, wherein input array comprises at least one directional module, at least one selection module, and at least one power module.

6. The device as described in claim 5, wherein a directional key is disposed on top of the directional module, a selection key is disposed on top of the selection module and a power key is disposed on top of the power module.

7. The device as described in claim 1, wherein the oil reservoir contains an oil absorbent material.

8. The device as described in claim 7, wherein the heating element and tube are disposed inside of the oil absorbent material.

9. The device as described in claim 1, wherein the mouthpiece includes an airflow restrictor configured to reduce a velocity of the vapor approaching the exit of the mouthpiece.

10. The device as described in claim 1, wherein the airflow intake is configured to allow a user to adjust the amount of air flowing into the device.

11. The device as described in claim 1 wherein, further featuring a child safety locking system.

12. The device as described in claim 1, wherein the micro controller and GPU are configured to cause the display to cause visual feedback when the vapor producing arrangement is activated.

13. The device as described in claim 1, wherein the storage module includes a selection of pre-installed video games.

14. The device as described in claim 1, wherein the device is configured for receiving and installing additional games.

15. The device as described in claim 1, further comprising an expandable memory module.

16. The device as described in claim 1, further comprising a wireless communication module enabling the device to communicate with and be controlled by online web application.

17. The device as described in claim 1, wherein the display is an OLED or LCD display.

18. The device as described in claim 1, wherein the device has more than one display.

19. The device as described in claim 1 wherein the device features feedback mechanisms, such as vibration or haptic feedback.

20. The device as described in claim 1, wherein the device includes a sound generating device.

21. The device as described in claim 1, wherein the controller is configured to cause the sound producing device to generate sound when the vapor generating device is activated.

22. The device as described in claim 1, wherein the controller and user inputs are configured to allow the user to adjust device settings such as temperature, voltage, and to navigate through the user interface options presented on the display.

23. The device as described in claim 1, wherein the power source is comprised of a rechargeable battery.

24. The device as described in claim 1, wherein the oil reservoir is refillable.

25. The device as described in claim 1, wherein the device contains more than one oil reservoir wherein the device is configured to allow the user to switch between the two reservoirs.

26. An electronic vape device comprising:
a mouthpiece, a battery, an airflow intake;
an oil reservoir comprising an oil absorbent cotton, and cavity enclosed by a top and bottom plug;
a vapor generating arrangement comprising of a tube, an air switch, and a mesh heating element wherein the oil absorbent cotton is disposed around the outside of the mesh heating element and wherein the mesh heating element creates a vapor cavity for air to flow through;
wherein the vapor heating mesh and tube are disposed inside of the reservoir cavity, wherein the top plug is configured to receive the top end of the tube and the lower plug is configured to receive the lower end of the mesh heating element;
a PCBA, comprising a microcontroller, a display, a storage module, user input array and a GPU, wherein the use input array comprises at least one directional module, at least one selection module, and at least one power module;
wherein a directional key is disposed on top of the directional module, a selection key is disposed on top of the selection module and a power key is disposed on the power module;
wherein the display is configured to provide the user visual feedback regarding the device's status, adjust setting and, allow the user to play video games.

27. The device as described in claim 26, wherein the airflow intake is configured to allow a user to adjust the amount of air flowing into the device.
